(19) United States
(12) Patent Application Publication
(10) Pub. No.: US 2019/0244146 A1
(43) Pub. Date: Aug. 8, 2019

(54) ELASTIC DISTRIBUTION QUEUING OF MASS DATA FOR THE USE IN DIRECTOR DRIVEN COMPANY ASSESSMENT

(71) Applicant: D&B BUSINESS INFORMATION SOLUTIONS, Dublin (IE)

(72) Inventors: Eoin Lane, Co. Dublin (IE); Ciara Keady, Dublin (IE); Maria McGourty, Co Kildare (IE); Joke O'Connor, Galway (IE)

(21) Appl. No.: 16/250,744

(22) Filed: Jan. 17, 2019

Related U.S. Application Data
(60) Provisional application No. 62/618,844, filed on Jan. 18, 2018.

(51) Int. Cl. G06Q 10/06; G06F 16/25; G06N 20/00

(52) U.S. Cl. CPC G06Q 10/0635; G06N 20/00; G06F 16/254

(57) ABSTRACT

An elastic distribution queuing system for mass data comprising: a data source; a matching engine for matching and/or appending a corporate identifier to data from the data source, thereby creating enhanced data; a distributed queuing system which determines how much the enhanced data is being ingested by the distributed queuing system and how many distributed processing nodes will be required to process the enhanced data; a structured streaming engine for distributed processing of the enhanced data from each the distributed processing node; a decision tree engine which identifies at least one data element from the enhanced data and determines a value of importance of the data element; a logistic regression model which determines the probability of failure of a corporate entity associated with the enhanced data based upon the value of importance of the data element; and an output of the results from the logistic regression model regarding the probability of failure for the corporate entity.

### CROSS REFERENCE TO RELATED APPLICATION

The present application claims priority to U.S. Provisional Patent Application No. 62/618,844 filed on Jan. 18, 2018, the entirety of which is incorporated by reference hereby.

### DESCRIPTION OF RELATED TECHNOLOGY

### 1. Field

The present disclosure pertains to an elastic distribution queuing system for mass data which determines how much of the data is being ingested by the distributed queuing system and how many distributed processing nodes will be required to process the data, thereby allowing near real-time determination of the probability of failure of a corporate entity based upon the value of importance of various data elements from the mass data.

### 2. Discussion of the Art

Credit rating information is traditionally based on company evaluation enriched with financial and industry information. Credit rating companies use their data to look for signals which aim to enhance scoring in individual reports to strive for an informative, accurate, and predictive credit score for each subject company.

One goal is to improve understanding of the determinants of company survival. Most prediction models focus on financial information or company demographics, which do not include predictions for company failures due to management (principal) failure.

The present disclosure utilizes a repository of director demographic data which can be used to analyze and predict company failure and potentially relate to director demographic factors. The relationship between such director demographic data elements and company performance—with respect to possible company statuses of Active, Dormant, Favorable and Unfavorable Out of Business—has been investigated along with how credit rating companies can utilize this information to drive an even more predictive credit score going forward.

Still, another problem addressed in the present disclosure is how to handle and process the sheer volume of mass data related to the above director demographic data element in a timely manner to allow for real-time determination of the effect of such data on the predictive credit score. Moreover, it is very difficult to process data in a timely and efficient manner due to the drastic variations in data volume over time. The present disclosure solves the problem of variation of data volume by means of an elastic distribution queuing of mass data which adds nodes when the volume increases and reduces nodes when the volume decreases. This unique application of elasticity in the distributed queuing system can calculate how many nodes are required based upon the incoming data which must be processed by the system, thereby saving processing time and cost.

The present disclosure also provides many additional advantages, which shall become apparent as described below.

### SUMMARY

An elastic distribution queuing system for mass data comprising: a data source; a matching engine for matching and/or appending a corporate identifier to data from the data source, thereby creating enhanced data; a distributed queuing system which determines how much the enhanced data is being ingested by the distributed queuing system and how many distributed processing nodes will be required to process the enhanced data; a structured streaming engine for distributed processing of the enhanced data from each the distributed processing node; a decision tree engine which identifies at least one data element from the enhanced data and determines a value of importance of the data element; a logistic regression model which determines the probability of failure of a corporate entity associated with the enhanced data based upon the value of importance of the data element; and an output of the results from the logistic regression model regarding the probability of failure for the corporate entity.

The distributed queuing system is a grate extract, transform and load queuing system. The distributed processing node is an elastic scalable distributed queueing system which processes the enhanced data in near real time across the structured streaming engine. The structured streaming engine comprises at least one Spark node and a Spark engine. The Spark engine enables incremental updates to be appended to the enhanced data.

The system further comprising machine learning by (a) learning the data element in the decision tree engine to confirm a feature set, and (b) the logistic regression model uses the feature set to train or test a data set to predict, thereby producing the probability of failure for the corporate entity.

The system wherein the elastic scalable distributed queueing system is a Kafka node.

A method for elastic distribution queuing of mass data comprising: retrieving data from at least one data source; matching and/or appending a corporate identifier to the data from the data source, thereby creating enhanced data; distributed queuing of the enhanced data to determine how much of the enhanced data is being created and how many distributed processing nodes will be activated to process the enhanced data; distributed processing of the enhanced data from each the distributed processing node via a structured streaming engine; identifying at least one data element from the enhanced data and determining a value of importance of the data element via a decision tree engine; determining the probability of failure of a corporate entity associated with the enhanced data based upon the value of importance of the data element via a logistic regression model; and outputting of the results from the logistic regression model regarding the probability of failure for the corporate entity.

Further objects, features, and advantages of the present disclosure will be understood by reference to the following drawings and detailed description.

### BRIEF DESCRIPTION OF THE DRAWINGS

FIG. 1 is a flow diagram of the elastic distribution queuing system according to the present disclosure;

FIG. 2 is a logic diagram of FIG. 1 depicting the data flow and decisions that are made on such data, i.e. elasticity requirements, variables of importance identified, and probability of failure;

FIG. 3 depicts hardware used to effectuate the elasticity within the distributed queuing system;

FIG. 4 is a flow diagram which provides an example of how data is processed via the elastic distribution queuing system according to the present disclosure;

FIG. 5 is a process overview of the system according to the present disclosure which results in a business failure prediction;

FIG. 6 is a decision tree of the present disclosure utilized to predict whether or not a business will fail;

FIGS. 7A and B are flow charts providing a high-level overview of the system components used to generate a failure prediction;

FIGS. 8A and B are flow charts depicting the four stage components used in the director driven model of the present disclosure;

FIG. 9 is a chart depicting the flow of the stages of the director driven company assessment model of the present disclosure;

FIG. 10 is a variable importance table generated by the present disclosure;

FIG. 11 is a variable importance table according to each decision tree;

FIG. 12 is an average variable importance table according to the present disclosure;

FIG. 13 is a chart showing information values according to the present disclosure;

FIG. 14 is shows an embodiment of a computer architecture that can be included in a system such as that shown; and

FIG. 15 is a system diagram of an environment in which at least one of the various embodiments can be implemented.

### DETAILED DESCRIPTION OF THE EMBODIMENT

This disclosure describes the use of three specific inputs, and ultimately leads to the production of an output to predict business failure due to management failure:

1. Input data: repositories of director and shareholder data (e.g., for the UK and Ireland market named ‘SHOPS’) typically hold a vast amount of demographic, relational, and positional data on the appointed directors and shareholders of a huge portion of companies in the world. This disclosure focuses on using this director data to predict businesses failure as the person actively “steering” a company is expected to have a significant impact on its performance. Director data includes information, such as, start date, resigned date, number of directors in office, director age, addresses, etc.
2. Decision Tree Model: As a well-known form of supervised learning, decision trees use already pre-classified data in order to learn which one of the other present data elements—or a combination thereof—have a strong correlation to the target variable. In the present disclosure, the decision tree uses the above described director dataset together with the Company Status (appended to the dataset from other data sources) as the target variable. It “learns” which data variables are of interest and provides these variables as an output, which is then labelled as a “feature set”.
3. Logistic Regression Model: The decision tree is used as an effective dimension reduction technique and the dimensions output from the decision tree analytics are fed to a regression model in order to predict which companies are going to fail.

1. Director Input Data

In order to build the most reliable decision trees, and depending on the market requirements, one can either use an entire director dataset, use only the data of incorporated companies, use only the dataset of recently appointed/retired directors, or carry out stratified sampling in order to reduce the size of the dataset. This allows technology to easily and more quickly process the data during the next steps.

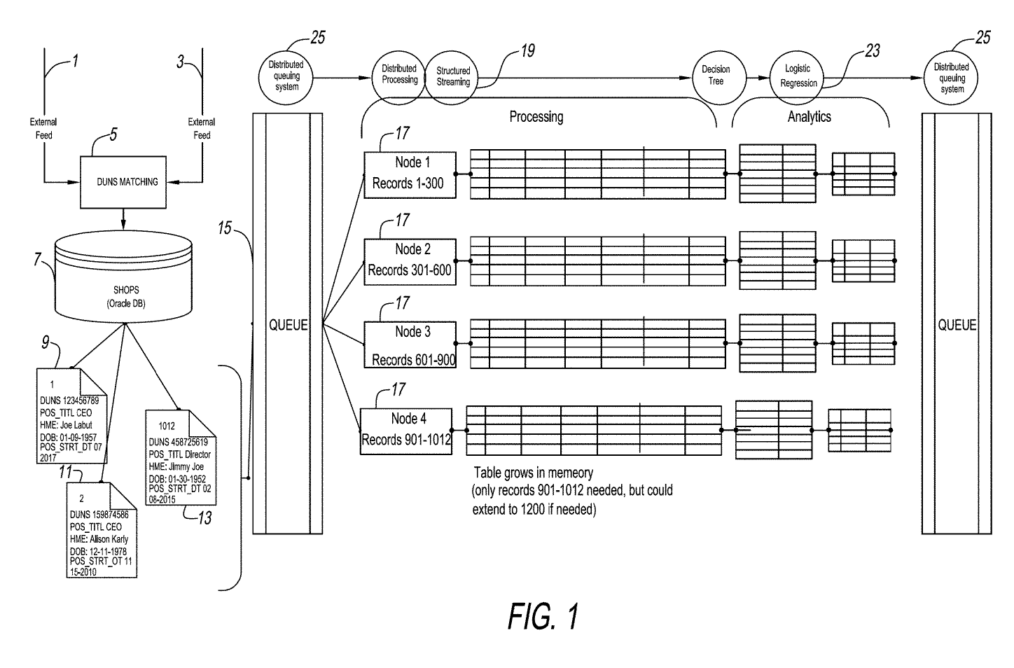

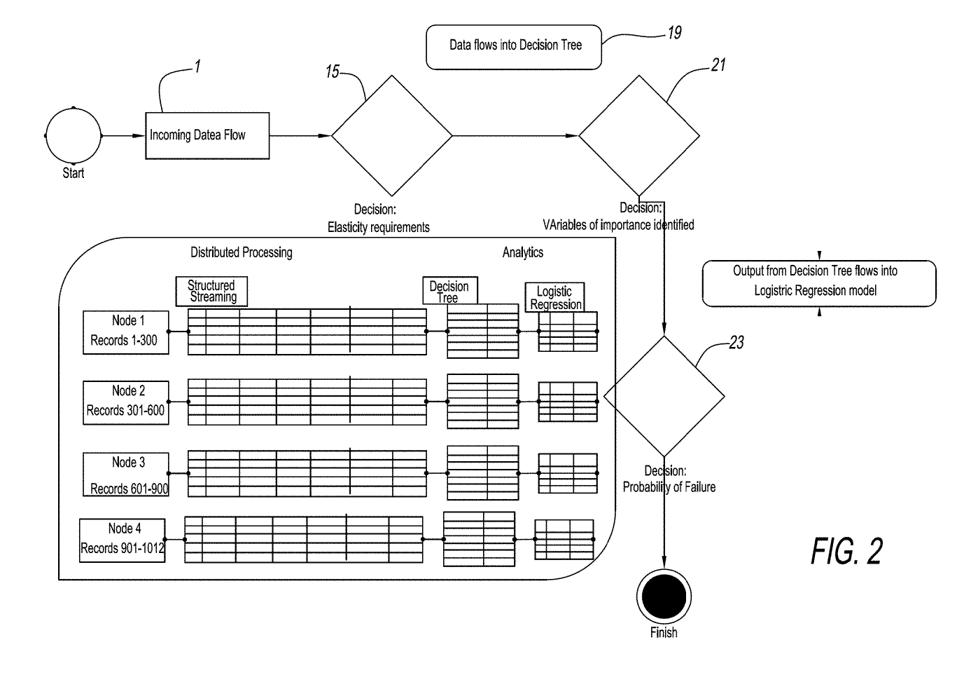

The present disclosure can be best understood by reference to the figures, wherein FIGS. 1 and 2 depicts an overall system used to process the dataset. External data feeds 1 and 3 are matched and/or appended to appropriate corporate identifiers (e.g., D-U-N-S Number) 5. Thereafter, the matched data is processed in a shareholder and principal's database (SHOPS) 7, such as an Oracle® database which appends at least a corporate identifier, name of shareholder, principal, officer, director, title, date of birth, etc. to the previously matched dataset, i.e. enhanced director driven data (9, 11 and 13).

The enhanced director driven data is then transmitted to an elastic distributed queuing system 15, which determines how much data it is receiving and then determines how many distributed processing nodes 17 will be required to timely and system cost-effectively process the enhanced director driven data. One example of an elastic distributed queuing system 15 is Apache Spark. Apache Spark is an open-source, distributed processing system used for big data workloads. Apache Spark utilizes in-memory caching and optimized execution for fast performance, and it supports general batch processing, streaming analytics, machine learning, graph databases, and ad hoc queries.

Apache Spark on Hadoop YARN is natively supported in Amazon EMR, where users can quickly and easily create managed Apache Spark clusters from the AWS Management Console, AWS CLI, or the Amazon EMR API. Additionally, a user can leverage additional Amazon EMR features, including fast Amazon S3 connectivity using the Amazon EMR File System (EMRFS), integration with the Amazon EC2 Spot market and the AWS Glue Data Catalog, and Auto Scaling to add or remove instances from a cluster. Also, a user can use Apache Zeppelin to create interactive and collaborative notebooks for data exploration using Apache Spark, and use deep learning frameworks like Apache MXNet with Spark applications.

Apache Hadoop™ is an open-source software framework for distributed storage and distributed processing of very large data sets on computer clusters built from commodity hardware. The core of Apache Hadoop™ consists of a storage part, known as Hadoop™ Distributed File System (HDFS), and a processing part called MapReduce. Hadoop™ splits files into large blocks and distributes them across nodes in a cluster,

Apache Spark is a fast and general-purpose cluster computing system. It provides high-level APIs in Java, Scala and Python, and an optimized engine that supports general execution graphs. Apache Spark™ provides programmers with an application programming interface centered on a data structure called the resilient distributed dataset (RDD), a read-only multiset of data items distributed over a cluster of machines, which is maintained in a fault-tolerant way. Spark's RDDs function as a working set for distributed programs that offers a restricted form of distributed shared memory. Apache Spark provides fast iterative/functional-like capabilities over large datasets, typically by caching data in memory. Apache Spark™ is an open-source cluster computing framework. It was developed in response to limitations in the MapReduce cluster computing paradigm, which forces a particular linear dataflow structure on distributed programs: MapReduce programs read input data from disk, map a function across the data, reduce the results of the map, and store reduction results on disk. As opposed to many libraries, Apache Spark is a computing framework that is not tied to Map/Reduce itself; however, it does integrate with Hadoop, mainly to HDFS. Elasticsearch-Hadoop allows Elasticsearch to be used in Spark in two ways: through the dedicated support available since 2.1 or through the Map/Reduce bridge since 2.0.

The distributed processing nodes 17 perform the following unique function according to the present disclosure. “Distributed processing” is a phrase used to refer to a variety of computer systems that use more than one computer (or processor) to run an application. This includes parallel processing in which a single computer uses more than one CPU to execute programs.

More often, however, “distributed processing” refers to local-area networks (LANs) designed so that a single program can run simultaneously at various sites. Most distributed processing systems contain sophisticated software that detects idle CPUs on the network and parcels out programs to utilize them.

Another form of distributed processing involves distributed databases. These are databases in which the data is stored across two or more computer systems. The database system keeps track of where the data is so that the distributed nature of the database is not apparent to users.

Each node is responsible for reading the data from the stream and creating a dynamic in memory table. Once the table is established aggregations and descriptive analytics can be performed.

As such, the distributed enhanced director driven data from each node 17 is then processed in parallel by structured streaming 19. For example, Apache Spark 2.0 adds the first version of a new higher-level API, structured streaming, for building continuous applications. An exemplary advantage is that it is easier to build end-to-end streaming applications, which integrate with storage, serving systems, and batch jobs in a consistent and fault-tolerant way.

The Spark Streaming API enables scalable, high-throughput, fault-tolerant stream processing of live data streams. Data can be ingested from many sources like Kafka, Flume, Twitter, etc., and can be processed using complex algorithms such as high-level functions like map, reduce, join and window. Finally, processed data can be pushed out to filesystems, databases, and live dash-boards. Resilient Distributed Datasets (RDD) is a fundamental data structure of Spark. It is an immutable distributed collection of objects. Each dataset in RDD is divided into logical partitions, which may be computed on different nodes of the cluster.

### Structured Streaming Model

Structured streaming automatically handles consistency and reliability both within the engine and in interactions with external systems (e.g., updating MySQL transactionally). This prefix integrity guarantee makes it easy to reason about the three challenges below:

1. Output tables are always consistent with all the records in a prefix of the data. For example, as long as each phone uploads its data as a sequential stream (e.g., to the same partition in Apache Kafka), the system is configured to always process and count its events in order.

2. Fault tolerance is handled holistically by structured streaming, including in interactions with output sinks. This was a major goal in supporting continuous applications.

3. The effect of out-of-order data is clear. Job outputs count are grouped by action and time for a prefix of the stream. If more data is later received, it is possible to have a time field for an hour in the past, and to simply update its respective row in MySQL. Structured streaming also supports APIs for filtering out overly old data if the user wants. But fundamentally, out-of-order data is not a “special case”: the query says to group by time field, and seeing an old time is no different than seeing a repeated action.

Another benefit of structured streaming is that the API is very easy to use, i.e. it is simply Spark's DataFrame and Dataset API. Users just describe the query they want to run, the input and output locations, and, optionally, a few more details. The system then runs their query incrementally, maintaining enough state to recover from failure, keep the results consistent in external storage, etc.

The distributed enhanced director driven data which has been processed through the structured streaming step 19 from each of nodes 17 is then transmitted to the machine learning decision tree 21 and then to logistic regression model 23, where the top data elements are first identified, and their Value of Importance is determined. The output from decision tree 21 is transmitted to a logistic regression model 23 to determine the probability of failure, i.e. predicted status and the confidence level identified. Thereafter, the results are transmitted to final distributed queuing system 25 to allow subscription or use downstream.

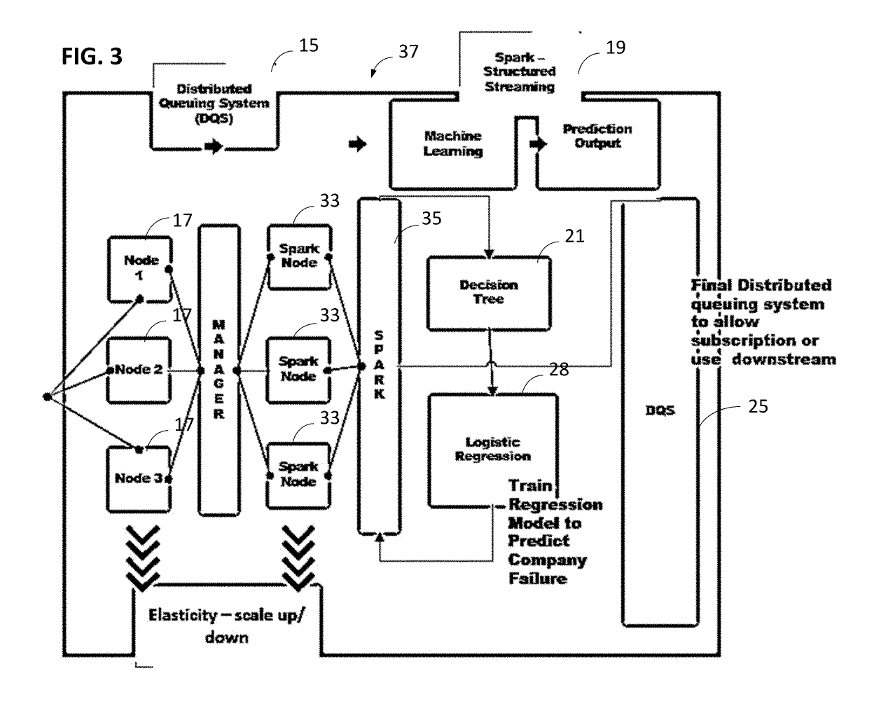

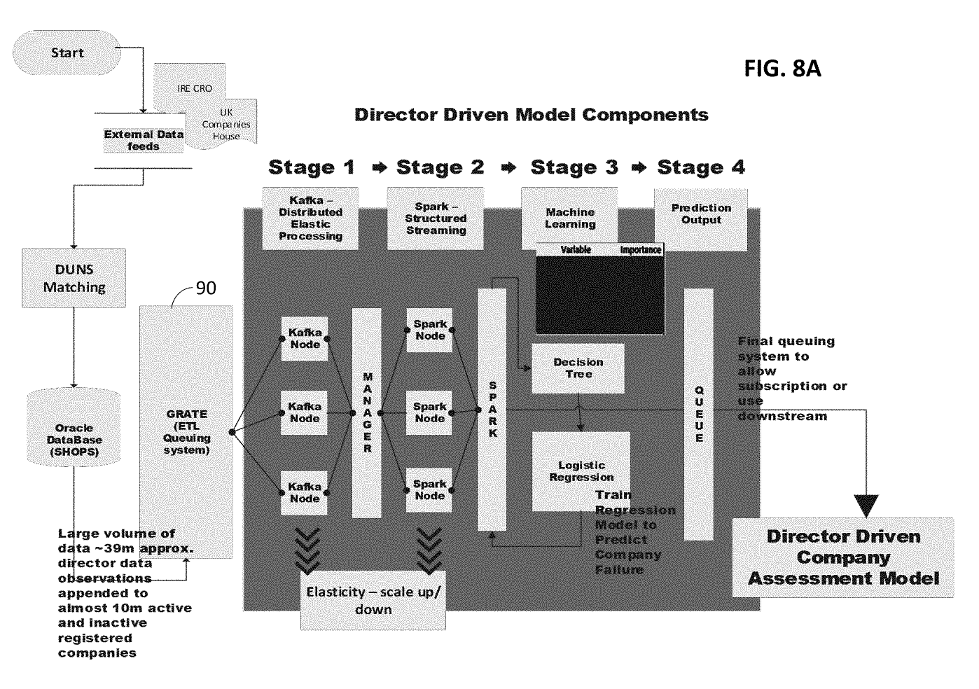

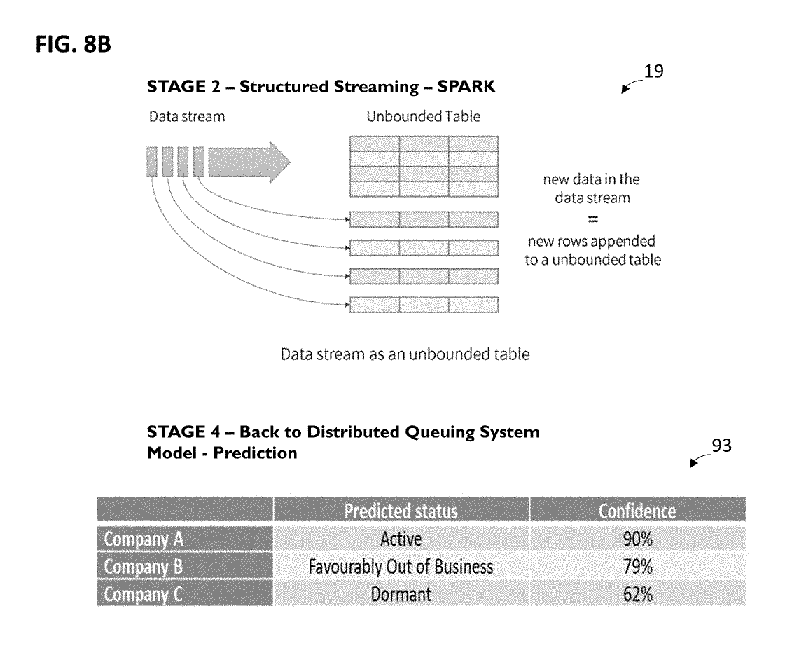

The unique hardware utilized in this elastic distribution queuing of mass data according to the present disclosure is discussed in FIG. 3, wherein the hardware is built upon the principle of elasticity within the distributed queuing system 15. Elastic distribution depends on the volume of data which is incoming at a given point in time. Depending on this, there is elastic distribution of the data to nodes 17 which are activated to process the data which will then flow to structured streaming process 19. Structured streaming 19 is done in Spark. The Spark environment allows for the structured streaming of the data and also the machine learning of decision tree 21 and logistic regression 23. Spark provides a machine learning library (MLlib) capability. Within the library, the system can leverage two algorithms:
Decision Tree & Random Forest Regression Algorithm (decision & forest)
Logistic Regression Algorithm (link)
   The Spark structured streaming 19 provides for the distributed processing of the data into the Spark engine 37. The majority of big or mass data can be in static structured tables; however, regular updates are being processed and require to be appended to the static data. Spark enables incremental updates to be appended to an unbounded table in memory from the streaming process. As show in FIG. 8A, data gets extracted from SHOPS 7 and reaches the distributed queuing by using GRATE 90. Once the queue has been hit it distributes the data into different nodes 17. Depending on the amount of data hitting the queue one or multiple distributed queuing nodes 17 are created. Depending on the hardware selected node size will vary. The system then utilizes manager 31, Spark nodes 33 and Spark 35 to scale up or down of the number of nodes 17 which are to be used to promptly and cost effectively process big data at any point in time. Depending on the number of queuing nodes 17, a corresponding number of SPARK processing nodes 33 will be created. The processing is structural streaming and a corresponding number of analytics nodes (e.g., decision tree 21 and random forest combined with logistic regression analytics 23).

As shown on FIG. 8A and 8B, there are four stages in the director driven model. For example, Stage 1 can be a Kafka distributed elastic processing 15 which processes data into a distributed streaming platform, e.g., Kafka. Apache Kafka™ provides a unified, high-throughput, low-latency platform for handling real-time data feeds. Its storage layer is, in its essence, a massively scalable pub/sub message queue architected as a distributed transaction log, making it highly valuable for enterprise infrastructures to process streaming data. Kafka clusters elastic scalable Kafka nodes 17 which process large volumes of data in real time across a distributed network. Kafka can also act as the central hub for real-time streams of data and are processed using complex algorithms in Spark Streaming. Kafka maintains events in categories called topics. Events are published by so-called producers and are pulled and processed by so-called consumers. As a distributed system, Kafka runs in a cluster, and each node is called a broker, which stores events in a replicated commit log. Once the data is processed, Spark Streaming can publish results into yet another Kafka topic or store in HDFS, databases or dashboards. While Kafka has been described herein as an exemplary embodiment, other implementations, different messaging and queuing systems can be used.

Stage 2 is a Spark structured streaming process 19 which provides a seamless input to the Spark engine 35. The majority of large data can be in static structured tables, however, regular updates are being processed and require to be appended to the static data. That is, as shown in FIG. 8B, Spark engine 35 enables incremental updates to be appended to an unbounded table in memory from the streaming process.

Stage 3 is a combination of machine learning techniques 92, i.e. a decision tree 21 which is supervised to learn the classified data to confirm feature set, and a logistic regression 23 which uses a feature set to “train” the data set. This combined approach in stage 3 enables data to be learned first and then tested or “trained” on in order to be able to produce prediction outcome.

Stage 4 is prediction output 93 determines the predicted status (e.g., active, favorably out of business, or dormant), as well as the confidence value measured in percentages.

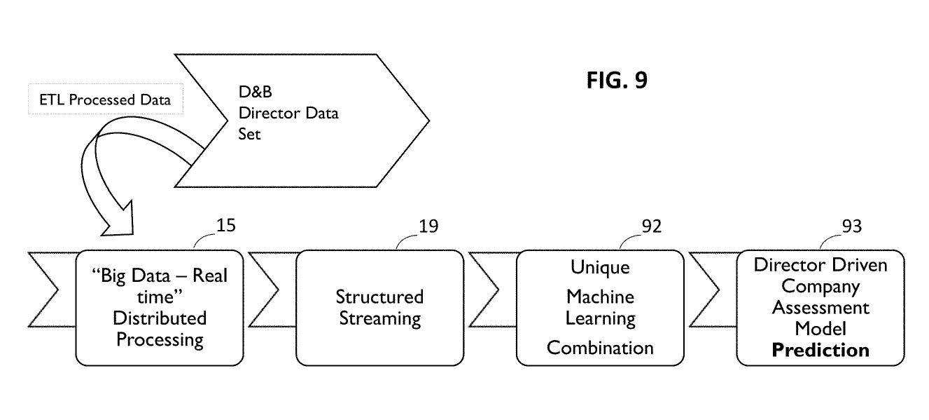

These stages 1-4 are shown in FIG. 9, which process new updated files regarding new companies, their shareholders, updates on existing shareholder structure, removal of shareholder(s), etc. These files are preferably updated daily and keyed into the system where every company is matched to a corporate identifier (e.g., a D-U-N-S Number). Once the keying of the records and D-U-N-S Number matching is completed, a daily batch process kicks off to update the SHOPS database (e.g., shareholders, officers and principals) and the data from SHOPS is then feed into GRATE ETL 90 for processing.

In shown in the following illustration example, long-resigned principals and long out of business companies were excluded, as well as non-incorporated businesses, from the nearly 34 million datasets. The remaining approximately 9 million records were reduced to a 10% sample of circa 900 k records with the following target variables (Company Status) attached:

| | TOTAL | SAMPLE |
|---|---|---|
| STATUS | COUNT | (10%) |
| Active (code 9074) | 6,832,731 | 683,273 |
| Dormant (code 9075) | 1,213,018 | 121,301 |
| Out of business—Favorable | 43,832 | 4,383 |
| (code 9076) | | |
| Out of business—Favorable | 929,941 | 92,994 |
| (code 9077) | | |

2. Decision Tree

Classification is a classic form of supervised learning, where the target variable for each observation is available in the dataset. A decision tree is an application to the classification problem, and its description can be found in academic and industry literature. It begins with the entire dataset as the “root node”, from where the algorithm chooses a data attribute on whose values (“classifiers”, “predictors”) to partition the dataset, creating the “branches” of a tree. The most important choice a decision tree makes is the selection of the most effective variable to split on next, in order to best map the data items into their predefined “classes”.

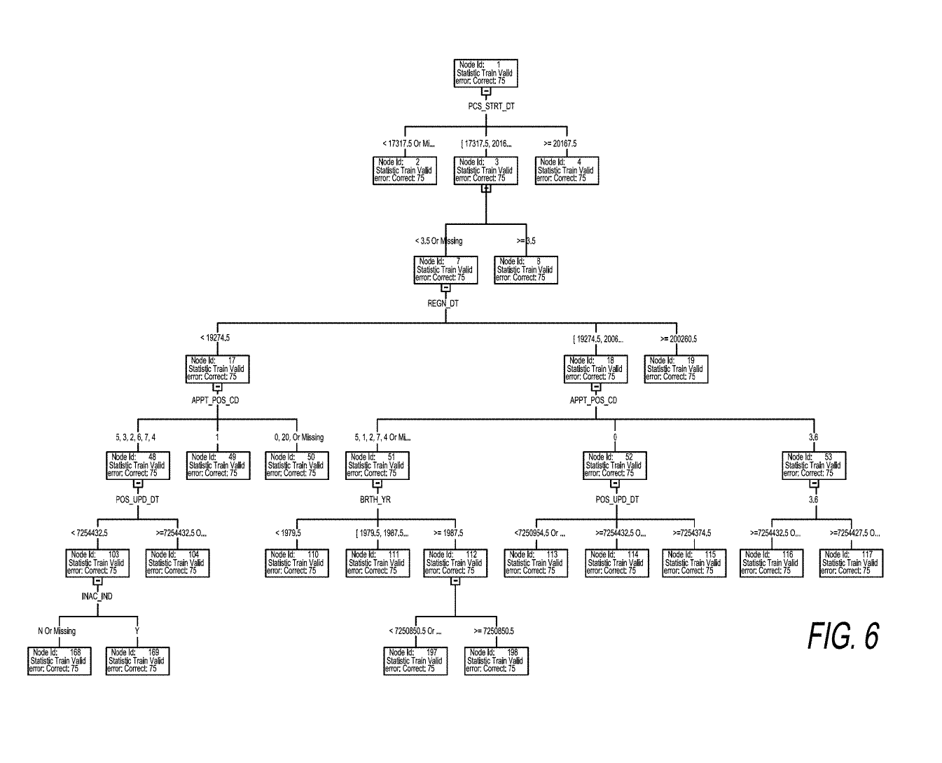

The goal is to develop the smallest tree possible which at the same time minimizes the number of misclassifications at each leaf node, meaning it classifies the available data points as correctly as possible. The members of each leaf node will be as homogeneous as possible with respect to their target variable, and at the same time as distinguished from members of other leaves as possible. The result of this algorithm can then be displayed in the form of a tree, each node represents a splitting attribute and the branches coming from the node are the possible values of that attribute. Quite commonly the decision tree gets grown too big, meaning it is “over-fitted” to the data. This later gets corrected by “pruning” the tree, using a previously set-aside portion of the dataset. The result could be a decision tree as shown in FIG. 6 which splits on the most informative data elements.

A second output of a decision tree, beside its tree-shaped visualization, is the Variable Importance information given. This gives a list of all the data variables that were available from the input data, and how relevant each one was for the final decision tree with regards to “classification information”. This is expressed in a numerical value, ranging from 0 (not relevant) to 1 (high usefulness).

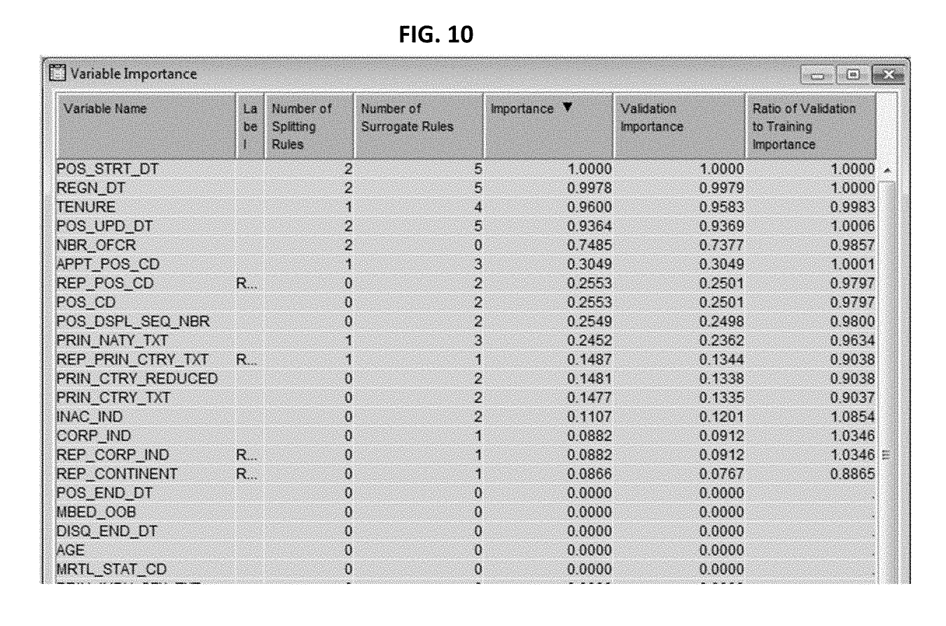

An example of what a Variable Importance table can look like is shown in FIG. 10.

The data elements identified to have the highest relevance for correctly assigning each instance to the correct target variable are ranked the highest.

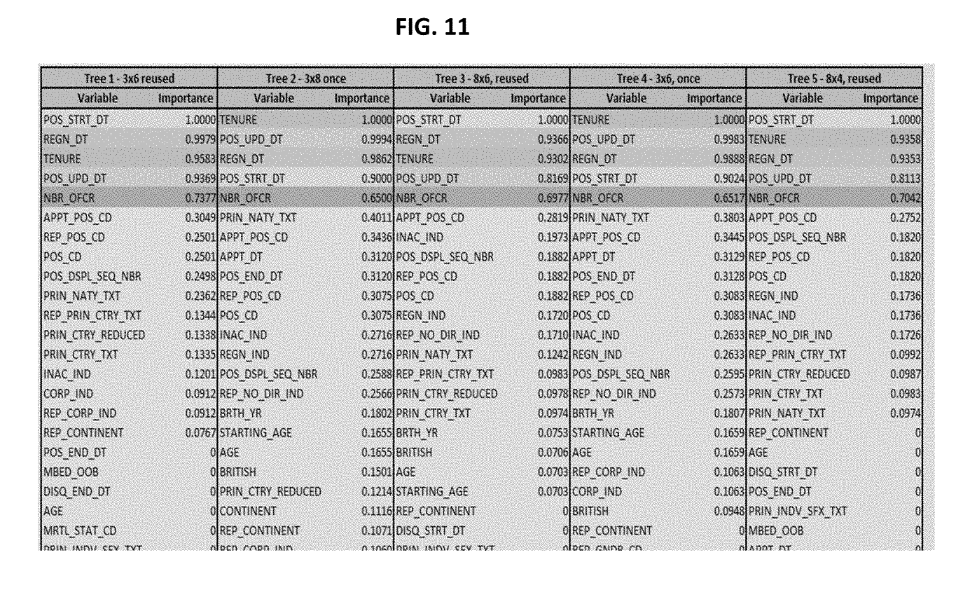

Due to the nature of decision tree splitting, the data elements chosen throughout the process can yield very different results in the end. In this visualization example different settings for breadth/depth/leaf size were implemented in parallel. And while all the best performing trees yielded slightly different results with regards to the exact order of variable importance, they all resulted in the same elements ranking among the top, for example as shown in FIG. 11 and the table below.

Across all the top 5 data elements which are considered to be of strong or very strong importance can clearly be identified to be:
Resignation date

As will be appreciated, using a different geographical market's dataset or different samples can lead to a very different result and output of this step. The overall most important data elements are provided as the output of this feature selection step, and become the input for the logistic regression model.

3. Logistic Regression

In an embodiment, a decision tree is employed as an effective dimension reduction technique and to train a regression model to help predict which companies are going to fail based on dimensions outputted from the decision tree analytics. In the case that a desired outcome can be defined for a sufficient number of businesses, a logistic regression model is built and configured to predict the likelihood that a particular business will fail.

The following model is fit to the data:

logit(p)=β₀+β₁X₁+βX₂+

where p is the probability of the presence of the characteristic of interest (e.g. customer ratings, business scale change),

$$odds = ( \frac{p}{1 - p} ) = \frac{probability of presence of characteristic}{probability of adsence of characteristic}$$

$$and$$

$$logit ( p ) = ln ( \frac{p}{1 - p} )$$

β₀ is the intercept, x are the predictors (e.g. five business ratings, and firmographic variables), and β are the regression coefficients. The fitted model is used to predict the outcome for businesses that where the outcome cannot be observed.
Dependent variable—The binary or dichotomous variable to predict, in this case, is a a business fail (0) or not (1).
Independent variable—Select the different variable that expected to influence the dependent variable, in this case it is the age of the director based on his or her date of birth.

In an embodiment, scikit-learn's LogisticRegression class in Python or Apache Spark Logistic Regression is employed to implement the regression, both of which are incorporated herein by reference thereto.

4. Output—Company Status Prediction and Confidence Based on Management Failure

The final output is a predicted company status for each record, accompanied by an associated confidence level. For example:

| | Predicted status | Confidence |
|---|---|---|
| Company A | Active | 90% |
| Company B | Favorably Out | 79% |
| | of Business | |
| Company C | Dormant | 62% |

### EXAMPLE

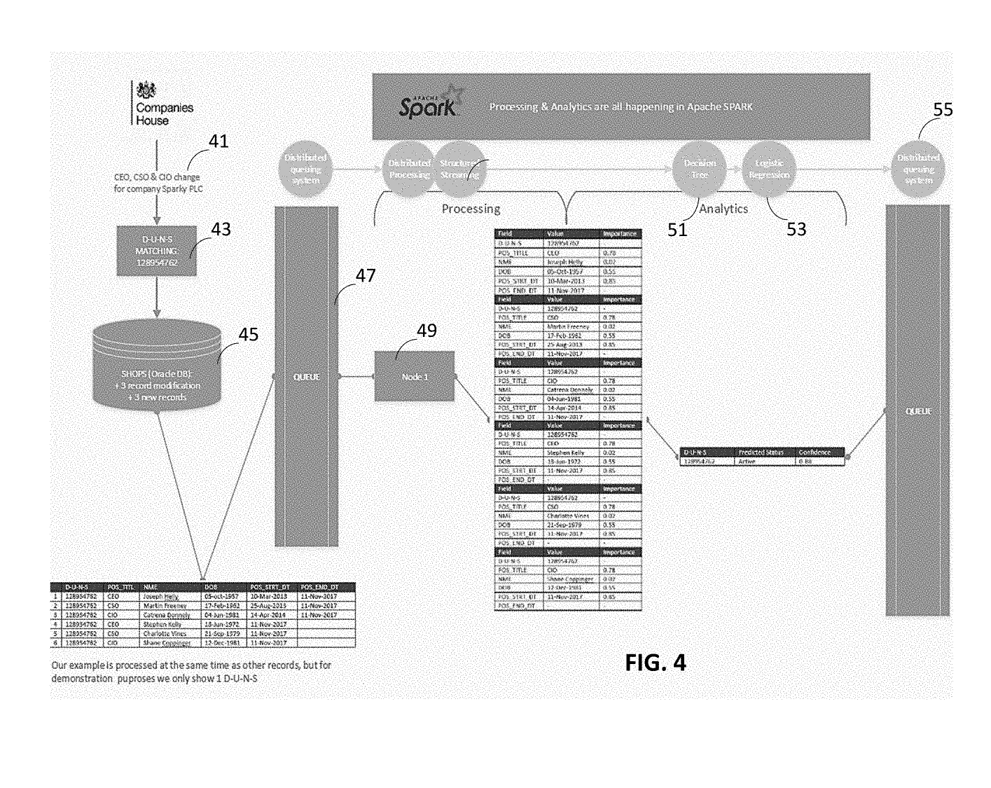

As shown in FIG. 4, shareholder and principal information is gathered 41. Once data is gathered, be it a change/new/delete of shareholder/principal the record is matched with a corporate identifier 43, such as a D-U-N-S number. If no D-U-N-S number is found, then a new one is created allowing the records to process through to a SHOPS database 45 (e.g., an Oracle database).

In the case where a new D-U-N-S number is created, a new record is also created in SHOPS 45 and is be picked up by the distributed queuing system 47. In case of modification and/or removal of shareholders/principals, SHOPS 45 updates the record for distributed queuing system 47 to be picked up. Several updates can be processed in parallel leading to possible high volumes of data hitting the distributed queuing system 47 at roughly the same time.

An example: Company Sparky PLC is an existing UK company that changed its' CEO, CSO and CIO. The present disclosure will pick up these three (3) changes from Companies House 1, match it 5 to, e.g., D-U-N-S number 128954762. In SHOPS 45 this means a modification of the 3 existing principal records by adding a position end date and creating three (3) new records containing information on the three (3) new principals, i.e. CEO, CSO and CIO.

Once these changes have been registered to SHOPS database 45, they are sent in real-time through GRATE ETL queuing system 90 to distributed queuing system 47. Depending on the volume of records that hits distributed queuing system 47, one or multiple nodes 49 are created to process this new information (distributed processing and structured streaming). Extract, Transform, and Load (ETL) is a data warehousing process that uses batch processing to help business users analyze and report on data relevant to their business focus. The ETL process pulls data out of the source, makes changes according to requirements, and then loads the transformed data into a database or BI platform to provide better business insights. With ETL as employed with embodiments as described herein, business leaders can make data-driven business decisions.

The 6 records (3 changes and 3 new records) are picked up by one or more nodes 49 and are be processed parallel by using this present disclosure.

Once the records have been assigned to node 49, the distributed enhanced director driven data are processed through the decision tree 51 providing two (2) possible outcomes with regards to company status prediction, i.e. Active or Out of Business. Once a status has been determined, logistic regression model 53 provides a probability of this outcome.

| | D-U-N-S | POS_TITL | NME | DOB | POS_STRT_DT | POS_END_DT |
|---|---|---|---|---|---|---|
| 1 | 128954762 | CEO | Joseph Helly | 5 Oct. 1957 | 10 Mar. 2013 | 11 Nov. 2017 |
| 2 | 128954762 | CSO | Martin Freeney | 17 Feb. 1962 | 25 Aug. 2013 | 11 Nov. 2017 |
| 3 | 128954762 | CIO | Catrena Donnely | 4 Jun. 1981 | 14 Apr. 2014 | 11 Nov. 2017 |
| 4 | 128954762 | CEO | Stephen Kelly | 13 Jun. 1972 | 11 Nov. 2017 | |
| 5 | 128954762 | CSO | Charlotte Vines | 21 Sep. 1979 | 11 Nov. 2017 | |
| 6 | 128954762 | CIO | Shane Coppinger | 12 Dec. 1981 | 11 Nov. 2017 | |

These records are then processed by using a decision tree 51 by making use of the pre-learned feature set and weights assigned to it and gets the outcome of ACTIVE.

| Field | Value | Importance |
|---|---|---|
| D-U-N-S | 128954762 | — |
| POS_TITLE | CEO | 0.78 |
| NME | Joseph | 0.02 |
| | Helly | |
| DOB | 5 Oct. | 0.55 |
| | 1957 | |
| POS_STRT_DT | 10 Mar. | 0.85 |
| | 2013 | |
| POS_END_DT | 11 Nov. | — |
| | 2017 | |
| D-U-N-S | 128954762 | — |
| POS_TITLE | CSO | 0.78 |
| NME | Martin | 0.02 |
| | Freeney | |
| DOB | 17 Feb. | 0.55 |
| | 1962 | |
| POS_STRT_DT | 25 Aug. | 0.85 |
| | 2013 | |
| POS_END_DT | 11 Nov. | |
| | 2017 | |
| D-U-N-S | 128954762 | — |
| POS_TITLE | CIO | 0.78 |
| NME | Catrena | 0.02 |
| | Donnely | |
| DOB | 4 Jun. | 0.55 |
| | 1981 | |
| POS_STRT_DT | 14 Apr. | 0.85 |
| | 2014 | |
| POS_END_DT | 11 Nov. | — |
| | 2017 | |
| D-U-N-S | 128954762 | — |
| POS_TITLE | CEO | 0.78 |
| NNE | Stephen | 0.02 |
| | Kelly | |
| DOB | 13 Jun. | 0.55 |
| | 1972 | |
| POS_STRT_DT | 11 Nov. | 0.85 |
| | 2017 | |
| POS_END_DT | — | — |
| D-U-N-S | 128954762 | — |
| POS_TITLE | CSO | 0.78 |
| NME | Charlotte | 0.02 |
| | Vines | |
| DOB | 21 Sep. | 0.55 |
| | 1979 | |
| POS_STRT_DT | 11 Nov. | 0.85 |
| | 2017 | |
| POS_END_DT | — | — |
| D-U-N-S | 128954762 | — |
| POS_TITLE | CIO | 0.78 |
| NME | Shane | 0.02 |
| | Coppinger | |
| DOB | 12 Dec. | 0.55 |
| | 1981 | |
| POS_STRT_DT | 11 Nov. | 0.85 |
| | 2017 | |
| POS_END_DT | — | — |

Processed through decision tree 51 we get the predicted status of Active for D-U-N-S 128954762.

Logistic regression model 53 adds a confidence code to this status prediction leaving the user with:

| | Predicted | |
|---|---|---|
| D-U-N-S | Status | Confidence |
| 128954762 | Active | 0.88 |

The results achieved by using the system of the present disclosure are picked up by final distributed queuing system 55, which can distribute the results to connected applications (e.g., Scoring, DBAI, Hoovers, Onboard, etc.), report generators, dashboards, or other interfaces and systems.

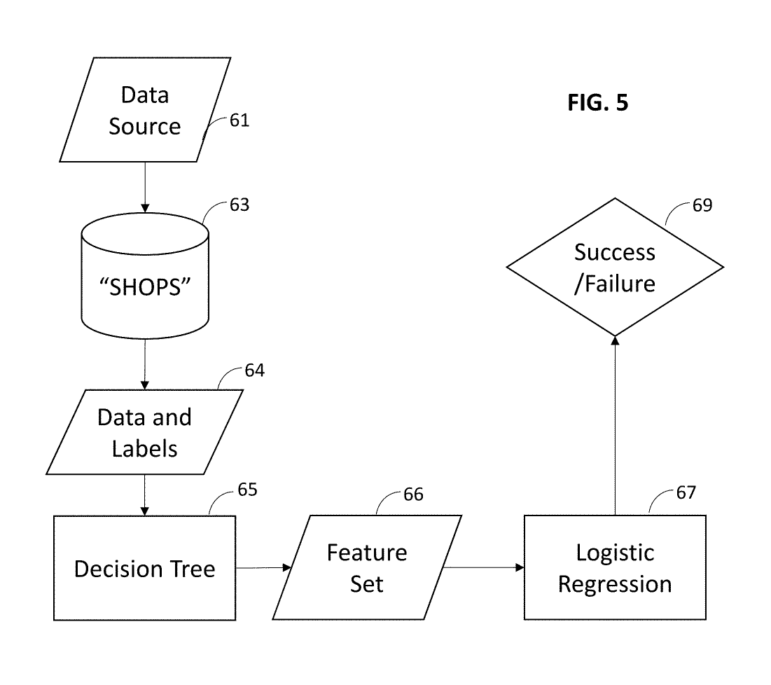

A process overview is shown diagrammatically in FIG. 5, wherein a data source 61 provides raw data input into SHOPS 63, wherein a corporate identifier (such as a D-U-N-S Number) is appended 64 to the input data received from data source 61 to produce distributed enhanced director driven data. Thereafter, the distributed enhanced director driven data is transmitted to a decision tree model 65 where a decision tree is created using supervised machine learning. The decision tree data, feature set 66, is than sent through logistic regression model 67 which produces a failure prediction output 69. FIG. 6 depicts a decision tree according to the present disclosure.

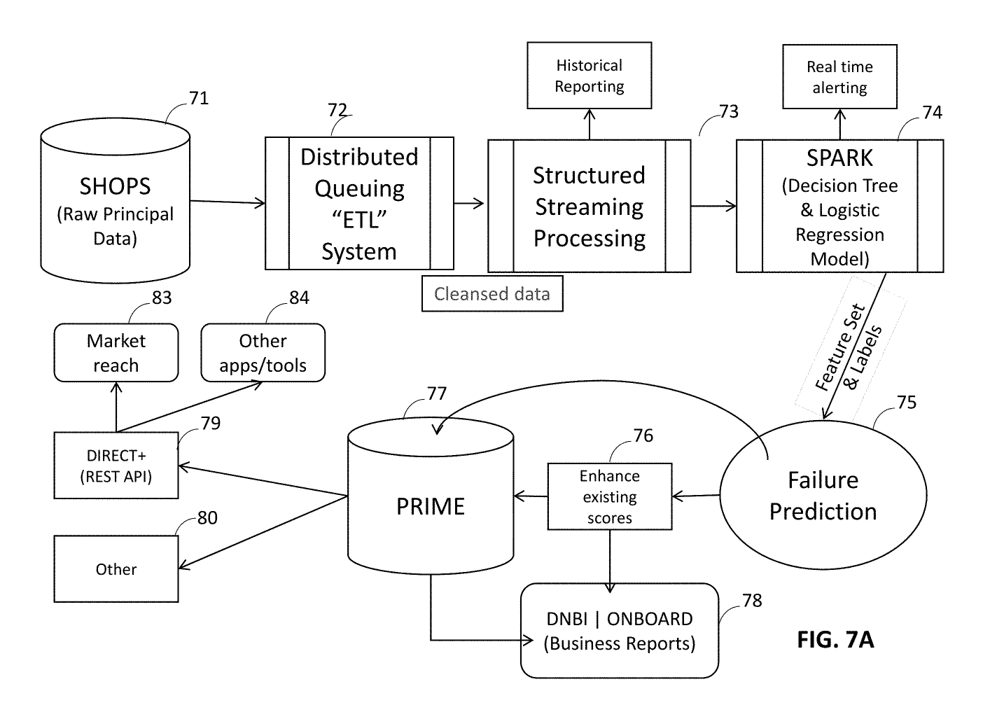

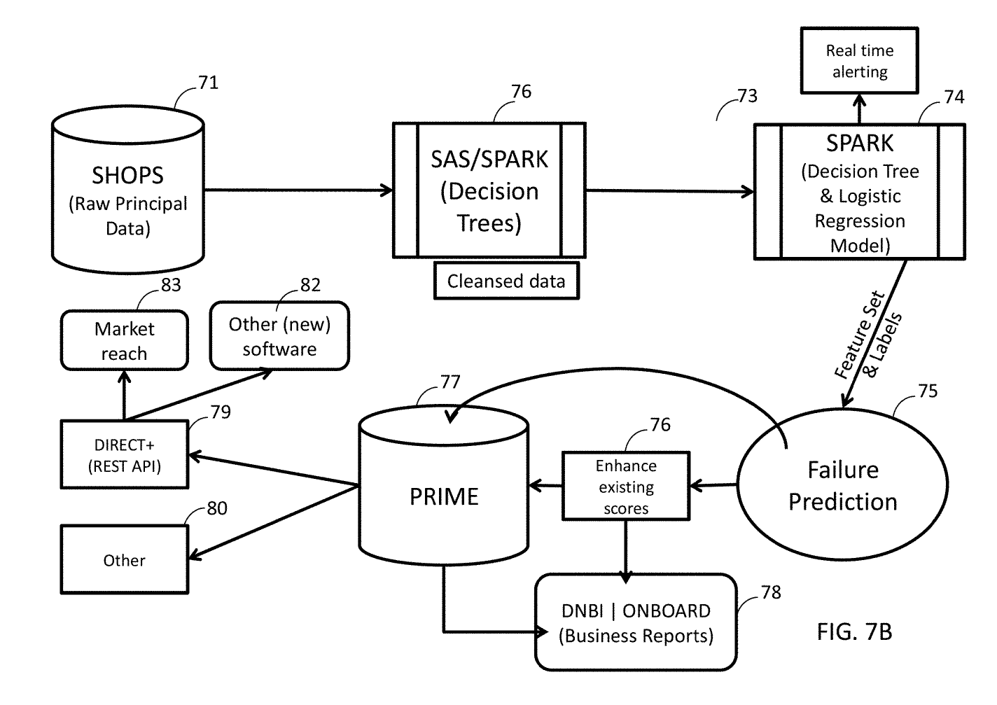

FIGS. 7A and 7B provide another overview of the process flow according to the present disclosure. In an embodiment, raw shareholder and principal data is appended to corporate identifier (e.g., a D-U-N-S Number) in SHOPS 71. Elements found in the SHOPS database 71 can include principal name, address, date of birth, position start date, tenure, country of residence, etc. This raw data can be cleansed, such by standardizing a country name, language specific characters handled, and standardize the forma and remove outliers for date of birth. The cleansed SHOPS data can then be transmitted to a distributed queuing system 72 which will determine the number of nodes required to timely and cost effectively handle the big data for processing. Thereafter, processing the data from the node(s) via a structured streaming process 73 such that the data from each node correspondence with all other nodes. In FIG. 7A, the decision tree and logistic regression model are handled together via Spark 74 prior to transmitting feature set and labels to failure prediction 75. The historical reporting part provides a user with the opportunity to provide descriptive analytics on the incoming data, e.g., number of male CEO's. The Real-Time alerting means that the system has ingested the historical data such that it can use this information to predict in near real-time and provide alerting for downstream applications to be made aware of these predictions. In FIG. 7B, the cleansed data is transmitted to SAS/Spark decision tree 76 which generates feature set and labels which are then processed in Spark Logistic regression model 77 before generating a failure prediction 76.

Failure prediction 75 can then be sent either to enhance existing scores 76 or to prime database 77. Thereafter, the enhanced existing scores and/or failure prediction can be used to generate a business report 78. In an embodiment, enhanced existing scores and/or failure prediction can be transmitted to Direct+(Rest API) 79 or other 80 (e.g., DBAI, Onboard, Hoovers, or other applications. The data in Direct+(Rest API) can be transmitted to a mobile App 81, other software 82. In an embodiment, the Real-Time alerting as described above is output to downstream applications to be made aware of predictions.

FIG. 10 is a screenshot of SAS decision tree inputs. The left column provides an overview of the data coming from SHOPS. Other columns are inputs in the decision tree.

FIG. 11 is a screenshot of SAS decision tree output. It shows the importance to the variables mentioned in FIG. 10.

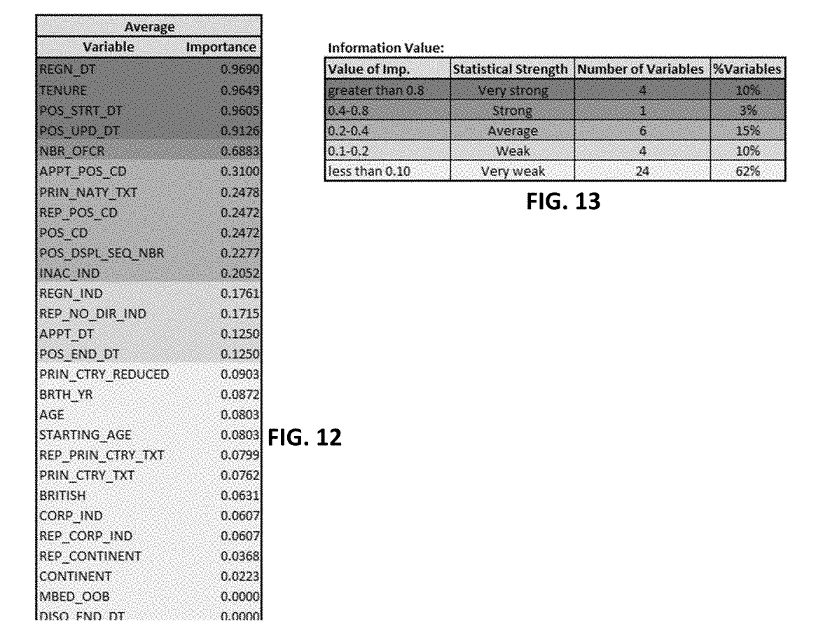

FIG. 12 is an aggregation/synopsis of FIG. 11.

FIG. 13 is a bucketing of the scores.

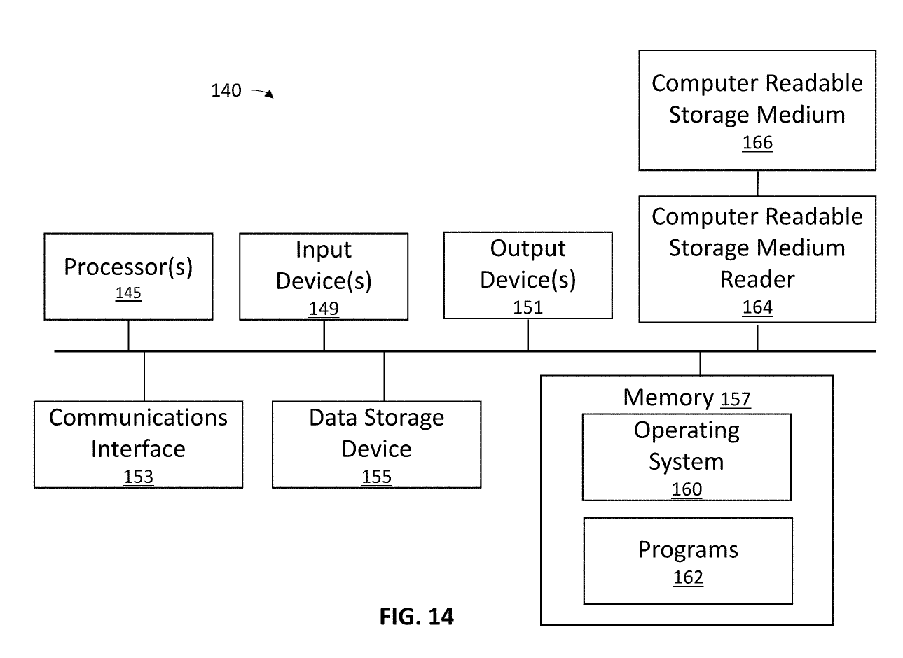

The invention disclosed herein can be practiced using programmable digital computers. FIG. 14 is a block diagram of a representative computer. The computer system 140 includes at least one processor 145 coupled to a communications channel 147. The computer system 140 further includes an input device 149 such as, e.g., a keyboard or mouse, an output device 151 such as, e.g., a CRT or LCD display, a communications interface 153, a data storage device 155 such as a magnetic disk or an optical disk, and memory 157 such as Random-Access Memory (RAM), Read Only Memory (ROM), each coupled to the communications channel 147. The communications interface 153 may be coupled to a network such as the Internet.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store an operating system 160 such as Microsoft Windows 7®, Windows 8®, Windows 10®, Mac OS®, or Unix®. Other programs 162 may be stored instead of or in addition to the operating system. It will be appreciated that a computer system may also be implemented on platforms and operating systems other than those mentioned. Any operating system 160 or other program 162, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 140 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 164, such as, e.g., a magnetic disk drive, magneto-optical drive, optical disk drive, or flash drive, may be coupled to the communications bus 147 for reading from a computer-readable storage medium (CRSM) 166 such as, e.g., a magnetic disk, a magneto-optical disk, an optical disk, or flash RAM. Accordingly, the computer system 140 may receive programs and/or data via the CRSM reader 164. Further, it will be appreciated that the term “memory” herein is intended to include various types of suitable data storage media, whether permanent or temporary, including among other things the data storage device 155, the memory 157, and the CSRM 166.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing.

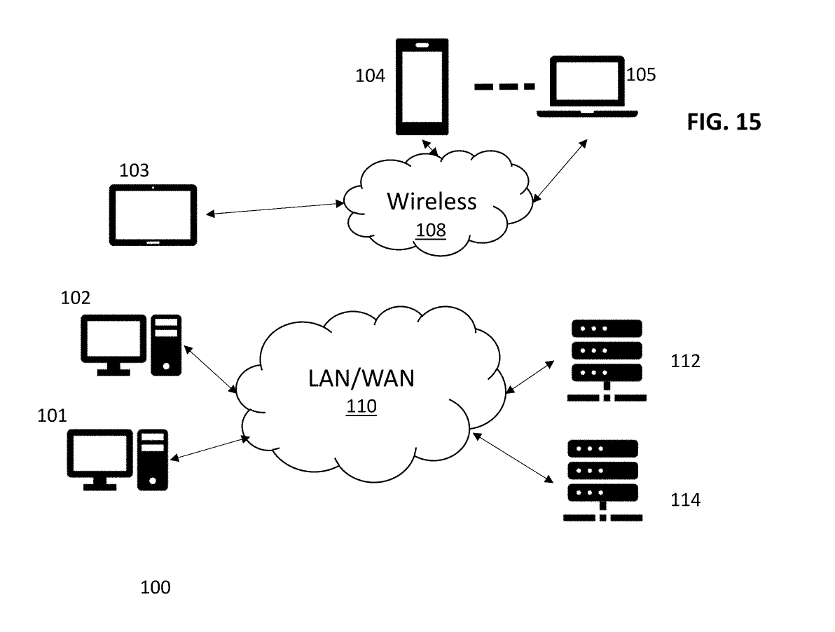

FIG. 15 shows components of one embodiment of an environment in which embodiments of the innovations described herein can be practiced. Not all of the components can be required to practice the innovations, and variations in the arrangement and type of the components can be made without departing from the spirit or scope of the innovations. As shown, system 100 of FIG. 15 includes local area networks (LANs)/wide area networks (WANs)—(network) 110, wireless network 108, client computers 102-105, Server Computer 112, and Server Computer 114.

In one embodiment, at least some of client computers 102-105 can operate over a wired and/or wireless network, such as networks 110 and/or 108. Generally, client computers 102-105 can include virtually any computer capable of communicating over a network to send and receive information, perform various online activities, offline actions, or the like. In one embodiment, one or more of client computers 102-105 can be configured to operate within a business or other entity to perform a variety of services. For example, client computers 102-105 can be configured to operate as a web server or the like. However, client computers 102-105 are not constrained to these services and can also be employed, for example, as an end-user computing node, in other embodiments. It should be recognized that more or less client computers can be included within a system such as described herein, and embodiments are therefore not constrained by the number or type of client computers employed.

Computers that can operate as client computer 102 can include computers that typically connect using a wired or wireless communications medium such as personal computers, multiprocessor systems, microprocessor-based or programmable electronic devices, network PCs, or the like. In some embodiments, client computers 102-105 can include virtually any portable personal computer capable of connecting to another computing device and receiving information such as, laptop computer 103, smart mobile telephone 104, and tablet computers 105, and the like. However, portable computers are not so limited and can also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client computers 102-105 typically range widely in terms of capabilities and features. Moreover, client computers 102-105 can access various computing applications, including a browser, or other web-based application.

A web-enabled client computer can include a browser application that is configured to receive and to send web pages, web-based messages, and the like. The browser application can be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client computer can employ the browser application to perform various activities over a network (online). However, another application can also be used to perform various online activities.

Client computers 102-105 can also include at least one other client application that is configured to receive and/or send content between another computer. The client application can include a capability to send and/or receive content, or the like. The client application can further provide information that identifies itself, including a type, capability, name, and the like. In one embodiment, client computers 102-105 can uniquely identify themselves through any of a variety of mechanisms, including an Internet Protocol (IP) address, a phone number, Mobile Identification Number (MIN), an electronic serial number (ESN), or other device identifier. Such information can be provided in a network packet, or the like, sent between other client computers, Server Computer 112, Server Computer 114, or other computers.

Client computers 102-105 can further be configured to include a client application that enables an end-user to log into an end-user account that can be managed by another computer, such as Server Computer 112, Server Computer 114, or the like.

Wireless network 108 is configured to couple client computers 103-105 and its components with network 110. Wireless network 108 can include any of a variety of wireless sub-networks that can further overlay stand-alone ad-hoc networks, and the like, to provide an infrastructure-oriented connection for client computers 103-105. Such sub-networks can include mesh networks, Wireless LAN (WLAN) networks, cellular networks, and the like. In one embodiment, the system can include more than one wireless network.

Wireless network 108 can further include an autonomous system of terminals, gateways, routers, and the like connected by wireless radio links, and the like. These connectors can be configured to move freely and randomly and organize themselves arbitrarily, such that the topology of wireless network 108 can change rapidly.

Wireless network 108 can further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks can enable wide area coverage for mobile devices, such as client computers 103-105 with various degrees of mobility. In one non-limiting example, wireless network 108 can enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 can include virtually any wireless communication mechanism by which information can travel between client computers 103-105 and another computer, network, and the like.

Network 110 is configured to couple network computers with other computers and/or computing devices, including, Server Computer 112, Server Computer 114, client computer 102, and client computers 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks can utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links can further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 can be configured to transport information of an Internet Protocol (IP). In essence, network 110 includes any communication method by which information can travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Server Computers 112, 114 include virtually any network computer configured as described herein. Computers that can be arranged to operate as severs 112,114 include various network computers, including, but not limited to personal computers, desktop computers, multiprocessor systems, microprocessor-based or programmable consumer electronics, network PCs, server computers, network appliances, and the like.

Although FIG. 15 illustrates Server Computer 112 and Server Computer 114 and client computers 103-105 each as a single computer, the embodiments are not so limited. For example, one or more functions of the Server Computer 112, Server Computer 114 or client computers 103-105 can be distributed across one or more distinct computers, for example, including the distributed architectures and distributed processing as described herein. As noted above, “distributed processing” includes to a variety of computer systems that use more than one computer (or processor) to run an application. This includes parallel processing in which a single computer uses more than one CPU to execute programs. Distributed processing also includes local-area networks (LANs) designed so that a single program can run simultaneously at various sites. Most distributed processing systems contain sophisticated software that detects idle CPUs on the network and parcels out programs to utilize them. Distributed processing can also include distributed databases.

Moreover, Server Computer 112, Server Computer 114 and client computers 103-105 are not limited to a particular configuration. For example, Server Computer 112, Server Computer 114 or client computers 103-105 can include a plurality of network computers that operate using a master/slave approach, where one of the plurality of network computers is operative to manage and/or otherwise coordinate operations of the other network computers. In other embodiments, the Server Computer 112, Server Computer 114 or client computers 103-105 can operate as a plurality of network computers arranged in a cluster architecture, a peer-to-peer architecture, and/or within a cloud architecture. Thus, embodiments are not to be construed as being limited to a single environment, and other configurations, and architectures are also envisaged.

Those of ordinary skill in the art will appreciate that the hardware in FIGS. 14 and 15 may vary depending on the implementation. Other internal hardware or peripheral devices, such as flash memory, equivalent non-volatile memory, or optical disk drives and the like, may be used in addition to or in place of the hardware depicted in FIGS. 14 and 15. Also, the processes of the illustrative embodiments may be applied to a multiprocessor data processing system without departing from the spirit and scope of the present invention.

Moreover, the system 100 can take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example.

In at least one of the various embodiments, information (e.g.: enhanced existing scores and/or failure prediction) from analysis components can flow to a report generator and/or dashboard display engine. In at least one of the various embodiments, report generator can be arranged to generate one or more reports based on the analysis. In at least one of the various embodiments, a dashboard display can render a display of the information produced by the other components of the systems. In at least one of the various embodiments, a dashboard display can be presented on a client computer accessed over network, such as server computers 112, 114 or client computers 102, 103, 104, 105 or the like.

Computers such as servers and clients can be arranged to integrate and/or communicate using API's or other communication interfaces. For example, one server can offer a HTTP/REST based interface that enables another server or client to access or be provided with content provided by the server. In at least one of the various embodiments, servers can include processes and/or API's for generating user interfaces and real time alerting as described herein.

It will be understood that each block of the flowchart illustration, and combinations of blocks in the flowchart illustration, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments.

While the present disclosure shows and describes several embodiments in accordance with the disclosure, it is to be clearly understood that the same may be susceptible to numerous changes apparent to one skilled in the art. Therefore, the present disclosures in not limited to the details shown and described, but also shows and includes all changes and modifications that come within the scope of the appended claims.

What is claimed is:

1. An elastic distribution queuing system for mass data comprising:
a data source;
a matching engine for matching and/or appending a corporate identifier to data from said data source, thereby creating enhanced data;
a distributed queuing system which determines how much said enhanced data is being ingested by said distributed queuing system and how many distributed processing nodes will be required to process said enhanced data;
a structured streaming engine for distributed processing of said enhanced data from each said distributed processing node;
a decision tree engine which identifies at least one data element from said enhanced data and determines a value of importance of said data element;
a logistic regression model which determines the probability of failure of a corporate entity associated with said enhanced data based upon said value of importance of said data element; and
an output of the results from said logistic regression model regarding said probability of failure for said corporate entity.

2. The system according to claim 1, wherein said distributed queuing system is a grate extract, transform and load queuing system.

3. The system according to claim 1, wherein said distributed processing node is an elastic scalable distributed queueing system which processes said enhanced data in near real time across said structured streaming engine.

4. The system according to claim 3, wherein the output further comprises a real-time alert to a downstream application.

5. The system according to claim 1, wherein said structured streaming engine comprises at least one Spark node and a Spark engine.

6. The system according to claim 5, wherein said spark engine enables incremental updates to be appended to said enhanced data.

7. The system according to claim 1, further comprising machine learning by (a) learning the data element in the decision tree engine to confirm a feature set, and (b) said logistic regression model uses said feature set to train or test a data set to predict, thereby producing said probability of failure for said corporate entity.

8. The system according to claim 3, wherein said elastic scalable distributed queueing system is a Kafka node.

9. A method for elastic distribution queuing of mass data, the method being performed by a computer system that comprises distributed processors, a memory operatively coupled to at least one of the distributed processors, and a computer-readable storage medium encoded with instructions executable by at least one of the distributed processors and operatively coupled to at least one of the distributed processors, the method comprising:
retrieving data from at least one data source;
matching and/or appending a corporate identifier to saud data from said data source, thereby creating enhanced data;
distributed queuing of said enhanced data to determine how much of said enhanced data is being created and how many distributed processing nodes will be activated to process said enhanced data;
distributed processing of said enhanced data from each said distributed processing node via a structured streaming engine;
identifying at least one data element from said enhanced data and determining a value of importance of said data element via a decision tree engine;
determining the probability of failure of a corporate entity associated with said enhanced data based upon said value of importance of said data element via a logistic regression model; and
outputting of the results from said logistic regression model regarding said probability of failure for said corporate entity.

10. The method according to claim 9, wherein said distributed queuing is performed by a grate extract, transform and load queuing system.

11. The method according to claim 9, wherein said distributed processing node is an elastic scalable distributed queueing system which processes said enhanced data in near real time across said structured streaming engine.

12. The method of claim 11, further comprising: outputting a real-time alert to a downstream application.

13. The method according to claim 9, wherein said structured streaming engine comprises at least one Spark node and a Spark engine.

14. The method according to claim 13, wherein said Spark engine enables incremental updates to be appended to said enhanced data.

15. The method according to claim 9, further comprising (a) learning the data element in the decision tree engine to confirm a feature set, and (b) said logistic regression model uses said feature set to train or test a data set to predict, thereby producing said probability of failure for said corporate entity

16. The method according to claim 11, wherein said elastic scalable distributed queueing system is a Kafka nod
